(19) United States
(12) Patent Application Publication
(10) Pub. No.: US 2012/0202129 A1
(43) Pub. Date: Aug. 9, 2012

(54) CROSSLINKED OR NON-CROSSLINKED AROMATIC (CO)POLYMERS AS PROTON CONDUCTORS FOR USE IN HIGH TEMPERATURE PEM FUEL CELLS

(75) Inventors: Aikaterini K. Andreopoulou, Achaia (GR); Andrea Voege, Dimos Erineou (GR); Fotis Paloukis, Achaia (GR); Christina Morfopoulou, Achaia (GR); Konstantinia D. Papadimitriou, Achaia (GR); Stylianos G. Neophytides, Achaia (GR); Joannis K. Kallitsis, Achaia (GR); Maria K. Daletou, Achaia (GR); Joannis Kalamaras, Athens (GR)

(73) Assignee: ADVENT TECHNOLOGIES, Athens (GR)

(21) Appl. No.: 13/367,855

(22) Filed: Feb. 7, 2012

(30) Foreign Application Priority Data
Feb. 7, 2011 (GR) 20110100058

(51) Int. Cl. H01M 8/10; H01M 4/86

(52) U.S. Cl. 429/409; 429/492; 429/482

(57) ABSTRACT

A polymer electrolyte comprising at least one aromatic polyether copolymer with main chain pyridine groups and side chain carboxylic acid or carboxylic ester or toluene or methoxy phenyl or hydroxyl phenyl or propenyl or styrene groups and/or pyridine groups, which have the ability to be covalently cross-linked.

### RELATED APPLICATION

This application claims priority to Greek Application No. 20110100058, filed Feb. 7, 2011, which is hereby incorporated by reference in its entirety.

### FIELD OF THE INVENTION

The present invention relates generally to the development of aromatic polyethers for use as electrolytes in High Temperature Polymer Electrolyte Membrane Fuel Cells.

### BACKGROUND OF THE INVENTION

Proton exchange membrane fuel cells (PEMFC) have attracted considerable attention as promising power generators for automotive, stationary, as well as portable power, due to their high-energy efficiency and low emissions. In that type of fuel cells the membrane is one of the key components in the design of improved polymer electrolyte membrane fuel cells. It has three main functions; as electrolyte medium for ion conduction and electrode reactions, as a barrier for separating reactant gases and as the support for electrode catalysts. The operation of fuel cells in temperatures up to

230° C. has the following advantages:
(1) both electrode's reaction kinetics are enhanced;
(2) the required cooling system is simplified due to the higher temperature difference between the coolant and the fuel cell;
(3) the heat that is produced can be recovered and reused resulting in higher total efficiency of the system;
(4) the CO tolerance is drastically enhanced (i.e. from 10-20 ppm of CO at 80° C., to 1000 ppm at 130° C., and up to 30000 ppm at 200° C. This high CO tolerance enables the use of hydrogen directly produced from a simple methanol reformer.
(5) when the operation temperature is close to 200° C. where the methanol reformation takes place, there is no need for heating or cooling of the produced fuel before feeding in the fuel cell stack.

A widely used method to obtain materials able to operate at elevated temperatures is the cross-linking which includes the ionic and covalent cross-linking. Ionic cross-linking which is based on interaction forces between different types of ionomers, such as acid-base polymers, results in polymer electrolyte membranes (PEMs) with improved stability and mechanical strength (Kerres, J. A. Fuel Cells 2005, 5, 230-247, Deimede, V.; Voyiatzis, G. A.; Kallitsis, J. K.; Qingfeng, L.; Bjerrum, N. J. Macromolecules 2000, 33, 7609-7617). However, ionic cross-linking is not effective at higher temperatures at which the membranes lose their mechanical integrity. In addition, a crucial problem of the state-of-the-art membranes which are used as polymer electrolytes in high temperature fuel cells (HT PEMFCs) is the deficient long-term durability at temperatures above 180° C. A promising approach to overcome these problems is the covalent cross-linking. To this direction many efforts have been made to cross-link aromatic polyethers containing reactive double bonds either by UV irradiation using appropriate initiators or by thermal treatment with the use of cross-linking agents or containing ethynyl groups following chemical cross-linking (Oh, Y. S.; Lee, H. J.; Yoo, M.; Kim, H. J.; Han, J.; Kim, K.; Hong, J. D.; Kim, T. H. Chem. Commun. 2008, 323, 309-315, Zhong, S.; Liu, C.; Na, H.; J. Membr. Sci. 2009, 326, 400-407, Jeong, M. H.; Lee, K. S.; Lee, J. S. Macromolecules 2009, 42, 1652-1658). These attempts resulted in materials with enhanced mechanical stability but they are applied mainly to low temperature electrolytes. On the other hand, many studies have been devoted to the covalent cross-linking of the high temperature electrolyte polybenzimidazole, PBI, mainly through thermal cross-linking with or without the use of proper cross-linkers (Noyé, P.; Li, Q. F.; Pan, C.; Bjerrum, N. J. Polym. Adv. Technol. 2008, 19, 1270-1275, Li. Q.; Jensen, J. O.; Savinell, R. F.; Bjerrum, N. J. Prog. Polym. Sci. 2009, 34, 449-477). An altering approach is to modify the chemical structure of the polymer in order to introduce groups able to be chemically or thermally cross-linked (Xu, N.; Guo, X.; Fang, J.; Xu, H.; Yin, J. J. Polym. Sci. Part A: Polym. Chem., 2009, 47, 6992-7002). In all cases, cross-linking led to materials with improved mechanical properties and oxidative stability.

### SUMMARY OF INVENTION

The present invention relates to aromatic polyethers for use as electrolytes in High Temperature Polymer Electrolyte Membrane Fuel Cells. These copolymers bear pyridine units in the main and side chain, as well as side units of methylene, toluene, carboxylic acid or carboxylic ester, propenyl or styrene, methoxy phenyl or hydroxyl phenyl. Copolymers bearing carboxylic acid groups can be cross-linked through the formation of oxadiazoles or imidazole rings. Copolymers that bear propenyl groups can be cross-linked in two ways. The first includes the direct cross-linking of the double bonds during the doping procedure with phosphoric acid at different temperatures. In the second way, the copolymers are cross-linked with the use of a bisazide and leads to the formation of aziridines or secondary amines. Copolymers bearing side styrene units are cross-linked either by thermal treatment at high temperatures or during the doping procedure with phosphoric acid at different temperatures. Copolymers that bear hydroxyl phenyl groups can form aromatic ether bonds via cross-linking. The produced membranes combine excellent mechanical properties with high thermal and oxidative stability. The membranes can be doped with phosphoric acid at high doping levels resulting in proton conductivities in the range of 10⁻² to 10⁻¹ S/cm.

One aspect of the invention is a polymer electrolyte comprising an aromatic polyether. In one embodiment, the polymer electrolyte comprises at least one aromatic polyether copolymer with main chain pyridine groups and side chain carboxylic acid or carboxylic ester or toluene or methoxy phenyl or hydroxyl phenyl or propenyl or styrene groups and/or pyridine groups, which have the ability to be covalently cross-linked.

Another aspect of the invention is a method of cross-linking the aromatic polyether described above. In one embodiment, the method comprises at least one of (a) heat treating said aromatic polyether copolymers, or (b) reacting said aromatic polyether copolymer with at least one cross-linking agent.

Yet another aspect of the invention is a cross-linked polymer electrolyte produced from the cross-linking method described above.

Still another aspect of the invention is a layered membrane electrode assembly comprising an anode electrode, a cathode electrode and a polymer electrolyte described above.

### BRIEF DESCRIPTION OF THE DRAWINGS

FIG. 1: Temperature dependence of the storage (E′) and loss (E″) modulus of copolymer 1 with x=70, y=0, z=30.

FIG. 2: TGA thermograms of copolymer 1 with x=60, y=20, z=20 before (-▪-) and after (-) the Fenton's test.

FIG. 3: Temperature dependence of the storage (E′) and loss (E″) modulus of cross-linked copolymer 1 with x=70, y=20, z=10 before (-□-) and after (-) the Fenton's test.

FIG. 4: Time dependence of doping level for copolymer 2 with R═CH₃ for different x percentages, at 100° C.

FIG. 5: Time dependence of doping level for copolymer 3 with R═SO₂ and x=70, y=0, z=30 before (—▪—) and after (--) the cross-linking at temperatures 80° C. and 50° C.

FIG. 6: Time dependence of doping level for copolymer 4 with m+o=60, n+p=40, o+p=20, q=0, r=0, at 140° C. before (-▪-) and after (-□-) thermal cross-linking.

FIG. 7: Temperature dependence of the storage (E′) and loss (E″) modulus of copolymer 1 with x=70, y=0, z=30 before (-▪-) and after cross-linking at different degrees: 100% (-♦-), 75% (--), 50% (-▴-) Kat 25% (-▾-).

FIG. 8: Temperature dependence of the storage (E′) and loss (E″) modulus of copolymer 1 with x=60, y=20, z=20 (-◯-) and of the 100% cross-linked copolymer (--).

FIG. 9: Temperature dependence of the storage (E′) and loss (E″) modulus of copolymer 3 with R═SO₂ and x=70, y=0, z=30 before (-) and after (- -) cross-linking.

FIG. 10: Temperature dependence of the storage (E′) and loss (E″) modulus of copolymer 2 with R═OH, x=60, y=0, z=40 before (-) and after (- -) cross-linking with 5 wt % of the cross-linker.

FIG. 11: Temperature dependence of the storage (E′) and loss (E″) modulus of copolymer 4 with m+o=60, n+p=40, o+p=15, q=0, r=0 before (-▪-) and after (--) thermal cross-linking.

FIG. 12: TGA thermograms of copolymer 3 with R═SO₂ and x=70, y=0, z=30 before (-) and after (---) cross-linking.

FIG. 13: I-V curves of copolymer 3 with R═SO₂ and x=70, y=0, z=30 at temperatures between 180° C.-225° C. with H₂/Air. Stoichiometric ratios λ_{H2}:1.2 and λₐᵢᵣ=2.

FIG. 14: I-V curves of cross-linked copolymer 4 with m=, n=, o+p=15, q=0, r=0 for temperatures between 180° C.-220° C. with H₂/O₂. Stoichiometric ratios λ_{H2}:1.2 and λ_{O2}=2.

FIG. 15: I-V curves of the cross-linked in phosphoric acid copolymer 3 with R═SO₂ and x=50, y=30, z=20, for temperatures between 180° C.-220° C. with H₂/Air. Stoichiometric ratios λ_{E2}:1.2 and λₐᵢᵣ=2.

FIG. 16: Long term durability test of the cross-linked with bisazide copolymer 3 with R═SO₂ and x=60, y=24, z=16, at a current load of 0.2 A/cm² and at 210° C.

FIG. 17: Solubility dependence versus the doping time in phosphoric acid at different temperatures, for the cross-linked copolymer 3 with R═SO₂ and x=60, y=24, z=16.

### DETAILED DESCRIPTION OF THE INVENTION

The present invention describes the development of copolymer electrolytes bearing pyridine units in the main chain and side units of methylene, pyridine, toluene, carboxylic acid or carboxylic ester, propenyl, styrene, methoxy phenyl or hydroxyl phenyl. Copolymers with different chemical structure were prepared and presented excellent mechanical properties, high thermal and oxidative stability and high values of proton conductivity after doping with phosphoric acid. Copolymers that bear carboxylic acid, carboxylic ester, propenyl or hydroxyl phenyl groups can be cross-linked forming oxadiazole, imidazole, aziridine and amine or aromatic ether groups. Copolymers bearing styrene groups can be cross-linked thermally or in phosphoric acid leading to the formation of a new carbon-carbon bond as in the case of the cross-linking in phosphoric acid of the copolymers bearing propenyl side units. The obtained cross-linked or non-cross-linked copolymers were used as electrolytes in high temperature PEM fuel cells. Membrane electrode assemblies were studied in single cell showing high conductivity values and exceptional stability at temperature higher than 220° C.

### DEFINITIONS

The following definitions are for convenient reference with respect to the following description and are not to be construed in a limiting manner.

The term Gel Permeation Chromatography (“GPC”) shall be understood to mean or refer to a method or technique used in order to determine the molecular weight (Mn and Mw) and dispersity of the copolymers.

The term Nuclear Magnetic Resonance (“NMR”) shall be understood to mean or refer to a method or technique used in order to identify the chemical and molecular structure of the copolymers and the proportion of the monomers in the copolymers.

The term Dynamic Mechanical Analysis (“DMA”) shall be understood to mean or refer to a method or technique used in order to identify the Tg (glass transition temperature) of the copolymers.

The term Thermogravimetric Analysis (“TGA”) shall be understood to mean or refer to a method or technique used in order to study the thermal and oxidative stability before and after Fenton's test.

The term solubility test shall be understood to mean or refer to a test used in order to determine the soluble fraction of the cross-linked membranes in dimethylacetamide (DMAc) as a qualitative method for the effectiveness of the cross-linking method. The cross-linked membranes were immersed in DMAc at 55° C. for 6 h. The remaining, not dissolved membranes were collected, dried under vacuum for 3 d at 160° C., and weighed. The solubility of the membranes was then obtained from the weight losses observed.

The term Fenton's Test shall be understood to mean or refer to a method or technique used in order to study and determine the oxidative stability of the copolymers.

The term single cell fuel cell test shall be understood to mean or refer to a method or technique used in order to study the performance of membrane electrode assembly and the measurement of proton conductivity in real testing conditions.

Compositions:

New polymer materials based on aromatic polyether backbones that bear pyridine units along the main chain as well as side chains and side units of methylene or toluene or carboxylic acid or carboxylic ester or propenyl or styrene or methoxy phenyl or hydroxyl phenyl groups able to be cross-linked, are described. These polymeric materials present excellent mechanical properties, high oxidative and chemical stability, high doping level and proton conductivity and are used as polymer electrolytes in high temperature PEM fuel cells. Furthermore, after cross-linking the obtained membranes present superior mechanical stability, which enables the use of the cross-linked materials at even higher temperatures. In specific, the procedures and materials that are described in the present invention provide low cost polymer membranes that combine all the required properties for their successful use in fuel cells operating up to 230° C. Chemical structures of these polymeric materials are given below:

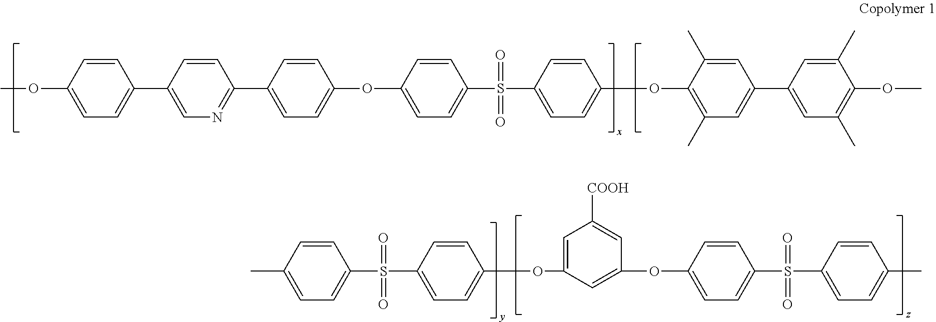

Where x ranges from about 5 to 95%, y ranges from 0 to 95% and z ranges from 5 to 95%, wherein x+y+z=100%

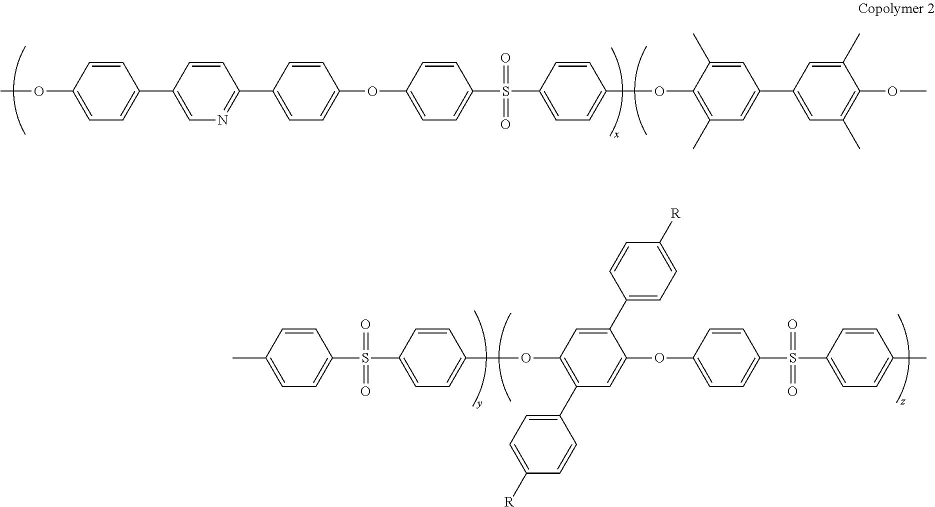

Where x ranges from about 50 to 80%, y ranges from 0 to 50% and z ranges from 5 to 50%, wherein x+y+z=100%

Copolymer 2:

R is selected from the group consisting of:

### R=—CH═CH₂, CH₃, COOH, COOCH₃, OCH₃, OH

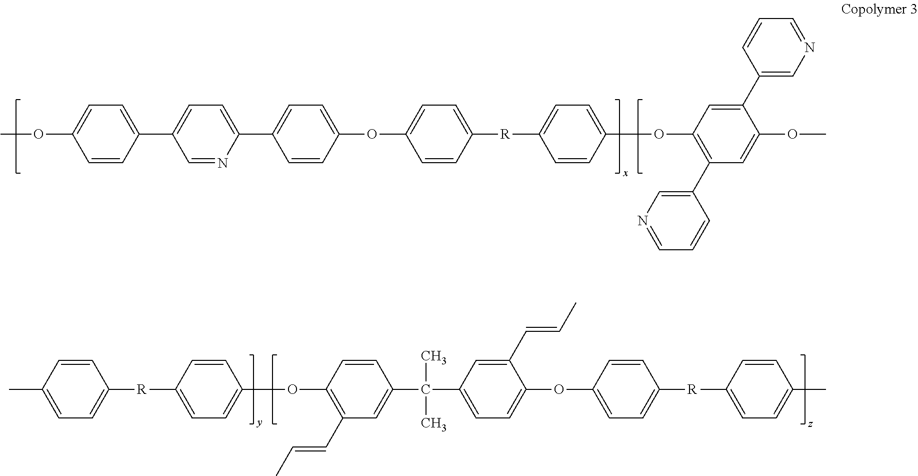

Where x ranges from about 50 to 70%, y ranges from 0 to 30% and z ranges from 5 to 30%, wherein x+y+z=100%

R is selected from the group consisting of:

### R═SO₂, OP-Ph

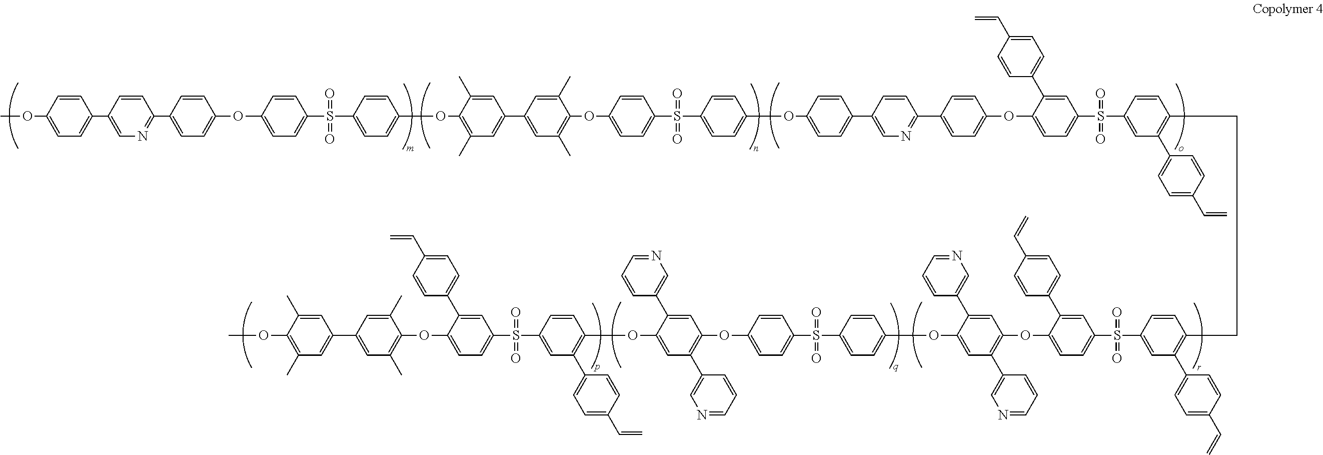

Where m ranges from about 10 to 80%, n ranges from 20 to 40%, o ranges from about 2 to 30%, p ranges from about 2 to 30%, q ranges from about 0 to 30% and r ranges from about 0 to 30%, wherein m+n+o+p+q+r=100%.

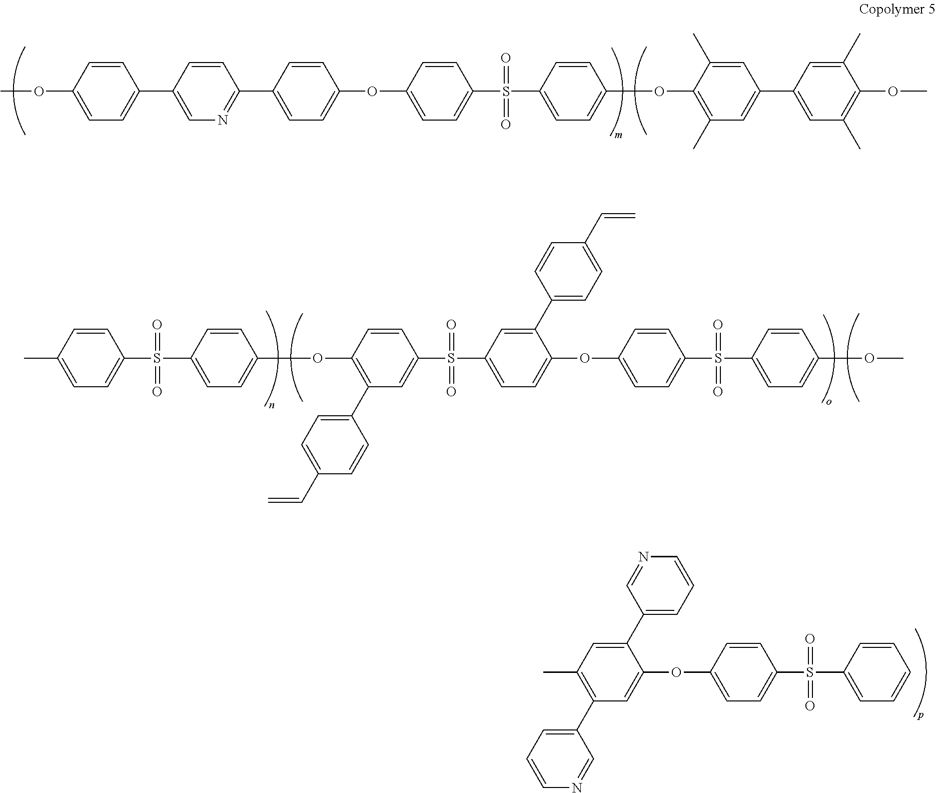

Where m ranges from about 40 to 90%, n ranges from 0 to 40%, o ranges from 5 to 40% and p ranges from 0 to 30%, wherein m+n+o+p=100%.

The membranes that bear carboxylic acid or carboxyl ester groups have a cross-linking ability forming oxadiazole rings with the use of ditetrazoles, poly(tetrazole)s or dihydrazides or forming imidazole rings using tetramines or poly(diamine)s. Membranes with propenyl groups can be cross-linked either in the presence of phosphoric acid during the doping procedure at temperatures between 80° C.-150° C. or by thermal treatment with the use of a bisazide as the cross-linking agent at temperatures between 150° C.-250° C. The membranes with side styrene groups are cross-linked by thermal treatment at temperatures between 200° C.-300° C. or in the presence of phosphoric acid during the doping procedure at temperatures between 80° C.-150° C. The membranes having side chain hydroxyl phenyl groups can be cross-linked through condensation reactions with aromatic fluorides such as decafluoro biphenyl etc, resulting in aromatic ether cross-linked bonds.

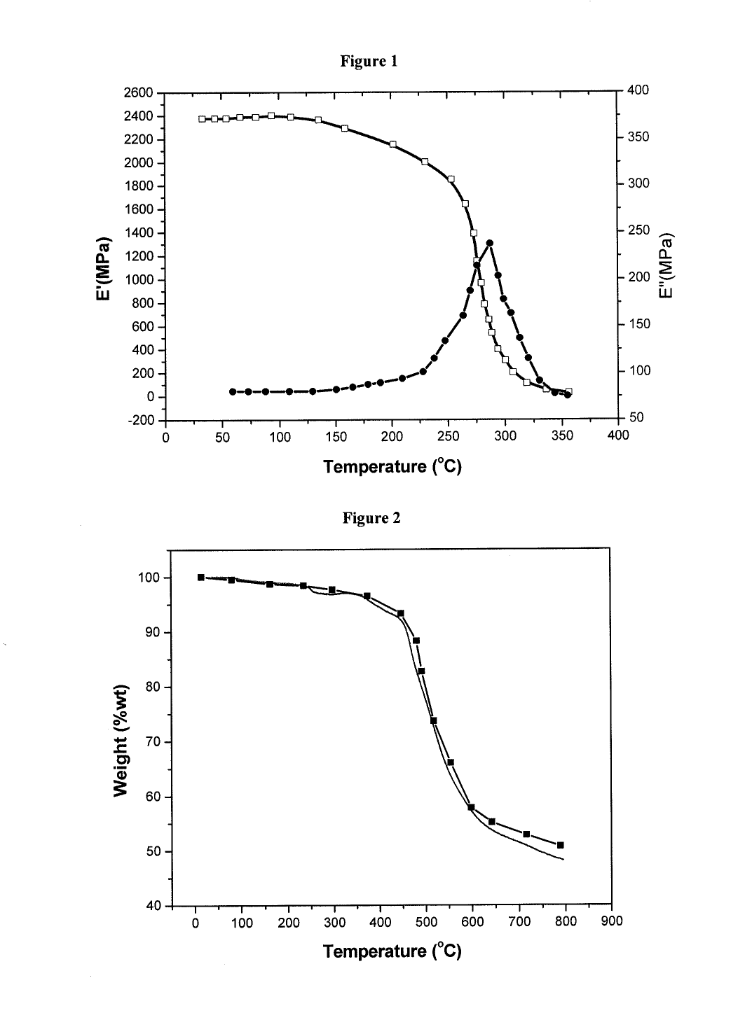

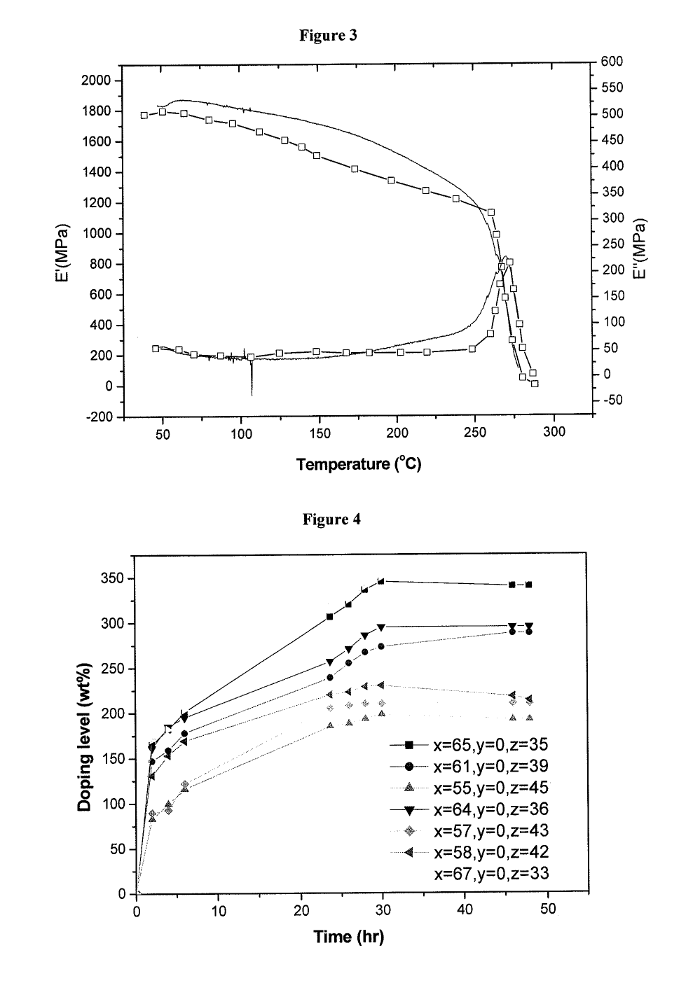

All copolymers have a glass transition temperature in the range of 240-300° C. depending on the composition. An example of dynamic mechanical analysis for copolymer 1 with x=70, y=0, z=30 is given at FIG. 1, where the glass transition temperature is 287° C. The oxidative stability of all copolymers was studied through Fenton's test where the membranes are exposed in a highly oxidative environment. Specifically, the membranes are immersed in hydrogen peroxide solution in the presence of ferrous ions at 80° C. for 48 h which leads to the formation of hydroxyl and hydroperoxide radicals. The oxidative addition of these species on the benzene ring of the polymers can result in chain scission or opening of the benzene ring. Such structural changes can also affect some of the physical properties of the materials. Nevertheless, all copolymers described in the present invention, retain their mechanical integrity after the Fenton's test. An example is depicted for copolymer 1 in FIGS. 2 and 3, where the membrane has the same thermal and mechanical properties before and after the treatment with the Fenton's reagent.

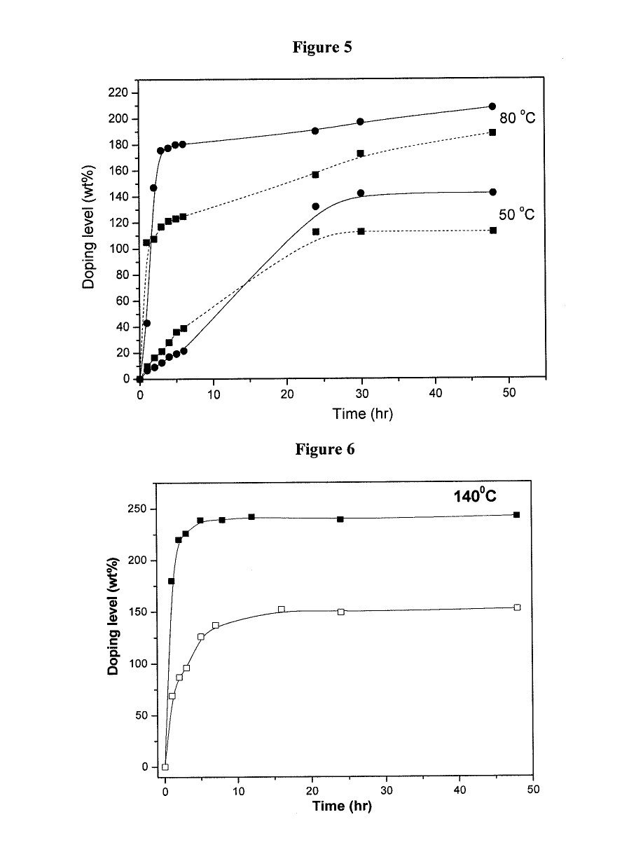

The membranes were imbibed with phosphoric acid at different temperatures and for different times, depending on the membrane's composition. The doping level is defined as the wt % content of the acid per gram of polymeric material. Examples of the time dependence of doping level for the virgin copolymers and for the cross-linked copolymers for different cross-linking degrees are given at FIGS. 4, 5 and 6 for copolymer 2 with R═CH₃ and for various x and y=0, copolymer 3 with R═SO₂ x=70, z=30 and y=0 and copolymer 4 with m+o=60, n+p=40, o+p=20, q=0, r=0, respectively. The doping level increases with the temperature reaching plateau values for high doping times. A doping level ranging between 100 wt % to 400 wt % is desirable and most preferably between 180 wt % και 300 wt %.

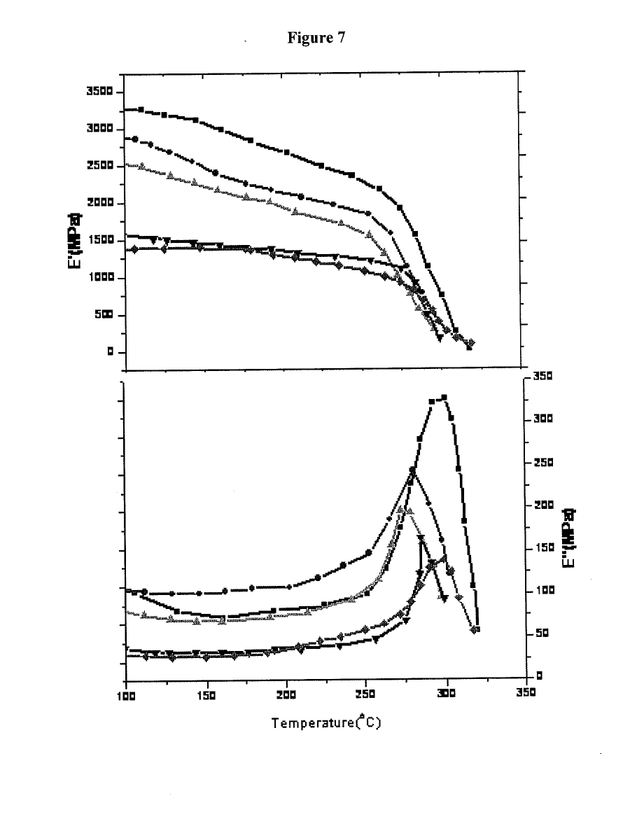

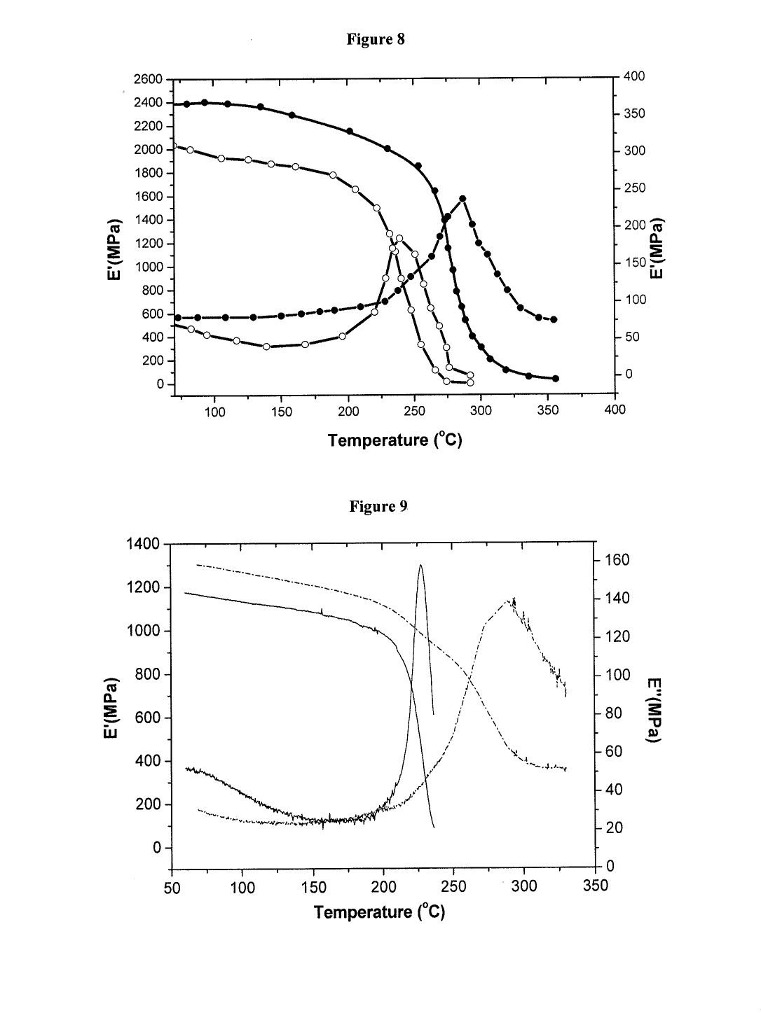

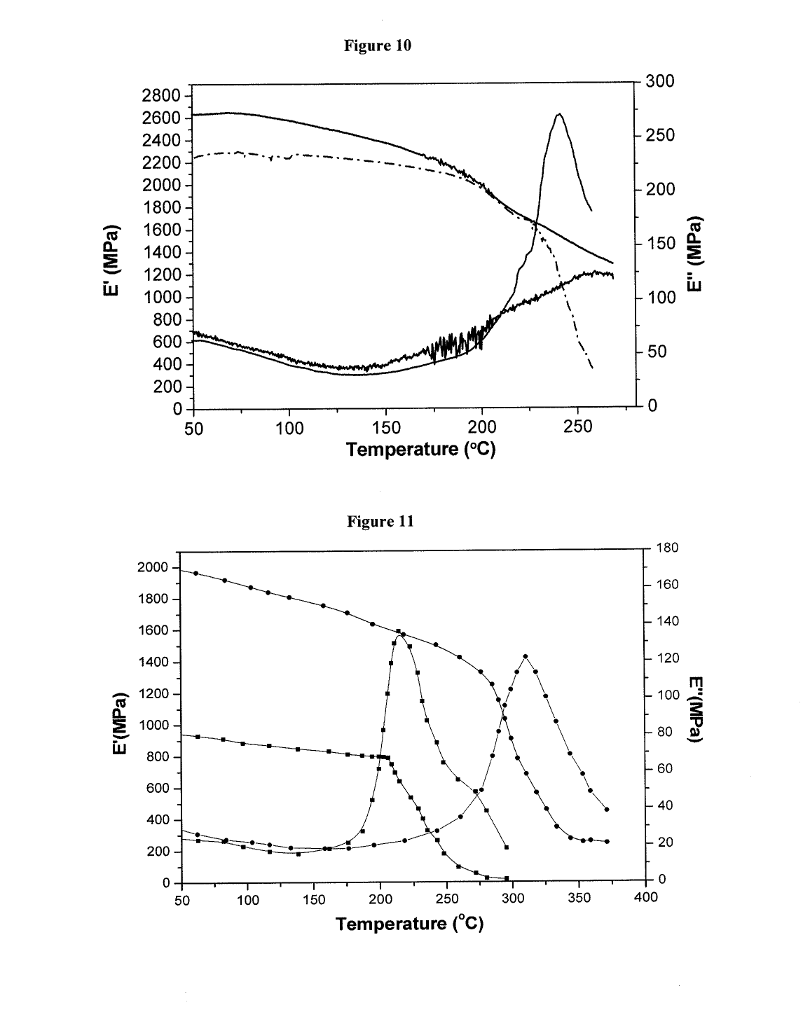

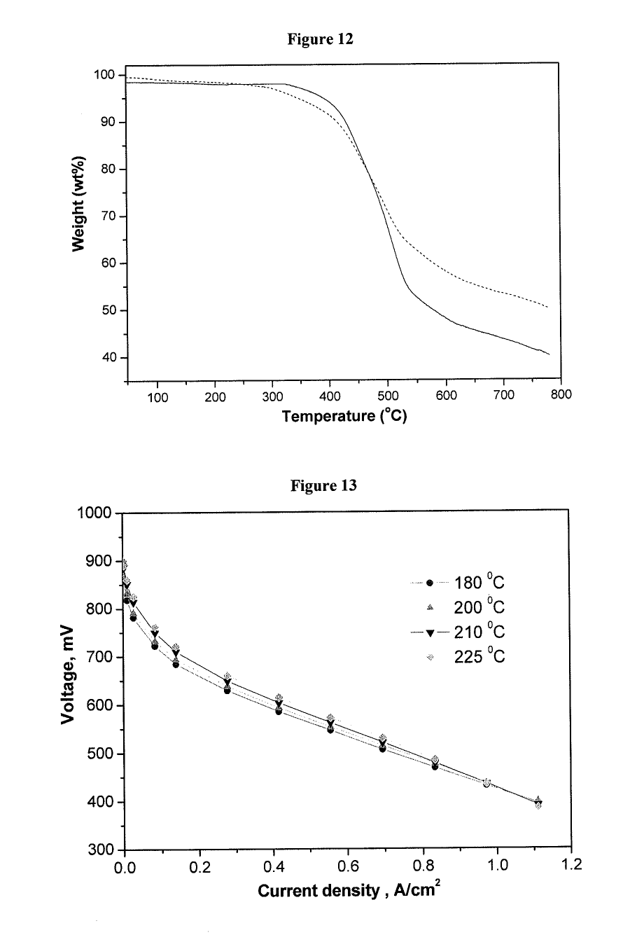

The physical and chemical structure of the membrane is been stabilized upon cross-linking leading for example to higher glass transition temperatures as it is shown in FIGS. 7, 8, 9, 10 and 11 and improved thermal stability as depicted in FIG. 12. Thus, the membranes can be employed at PEMFCs operating at temperature as high as 230° C. without deterioration. By changing the cross-linking density, membranes with tailor made properties can be prepared. The doping level, the glass transition temperature (T_{g}), the thermal and mechanical stability of the membranes can be controlled. The biggest advantage of high temperature operation is that the catalyst tolerance in impurities is enhanced giving the ability to use reformate hydrogen with high CO content. An additional advantage of high temperature operation (˜230° C.) is the possible combination of a methanol reformer within a high temperature PEM fuel cell which opens the possibility for an integrated system, meaning an internal reforming alcohol fuel cell. (Triantafyllopoulos, N.; Geormezi, M.; Neophytides, S.; loannides, T.; Avgouropoulos, G.; Papavasiliou, I.; Daletou, M.; Kallitsis, J.; Internal Reforming Alcohol High Temperature PEM Fuel Cell, US Pub No: US-2010-0062293, Int. Pub No: WO 2010/029431).

The membrane electrode assemblies were prepared with the following procedure.

The carbon substrate of the electrode is either carbon paper or cloth. A microporous layer is deposited on top of the substrate comprising of carbon (20-70% wt) and a hydrophobic polymer (30-80% wt). Specifically, a PTFE emulsion is mechanically mixed with carbon for 30 minutes. The main part of the solvent is being removed through filtration. The resulted ink is applied on the substrate and after thermal treatment at 350° C. for 30 min, this renders hydrophobic.

The Pt/C catalyst is mixed with a dimethylacetamide copolymer solution until the catalyst is homogeneously dispersed. The weight ratio of platinum to carbon is from 1:9 to 4:6 and most preferably 3:7, while the concentration of copolymer solution is 1-4 wt %. The weight ratio of the catalyst to the ionomer is from 7:3 to 1:1. The Pt/C/ionomer ink is applied on the microporous layer after evaporation of the solvent. The viscosity of the ink is very critical for the final surface of the catalytic layer. The electrodes are dried under vacuum at 190° C. for 1-2 h and the final Pt loading is 0.5-1 mg/cm².

The membrane electrode assembly is prepared by hot pressing of the anode electrode, the doped polymeric membrane and the cathode electrode applying an assembling force of 10-30 kg/cm² at 100-200° C. for 5-20 min, and preferably 20 kg/cm² at 150° C. for 15 min. The active area of the electrodes is 25 cm² and the membrane with a thickness of 60-200 μm has an acid doping level of 100-400 wt %.

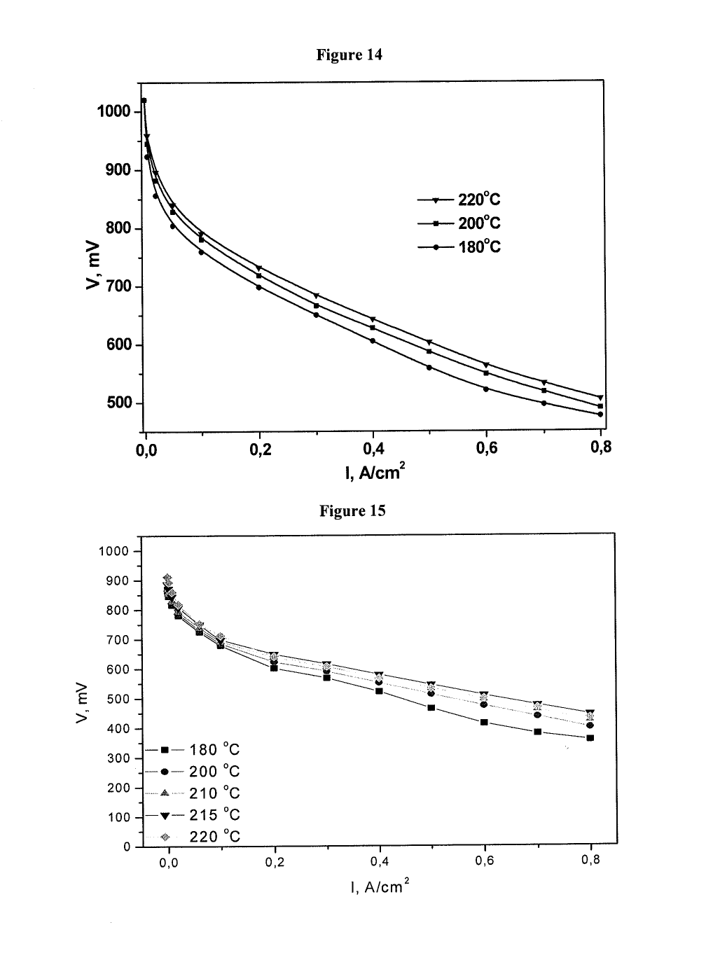

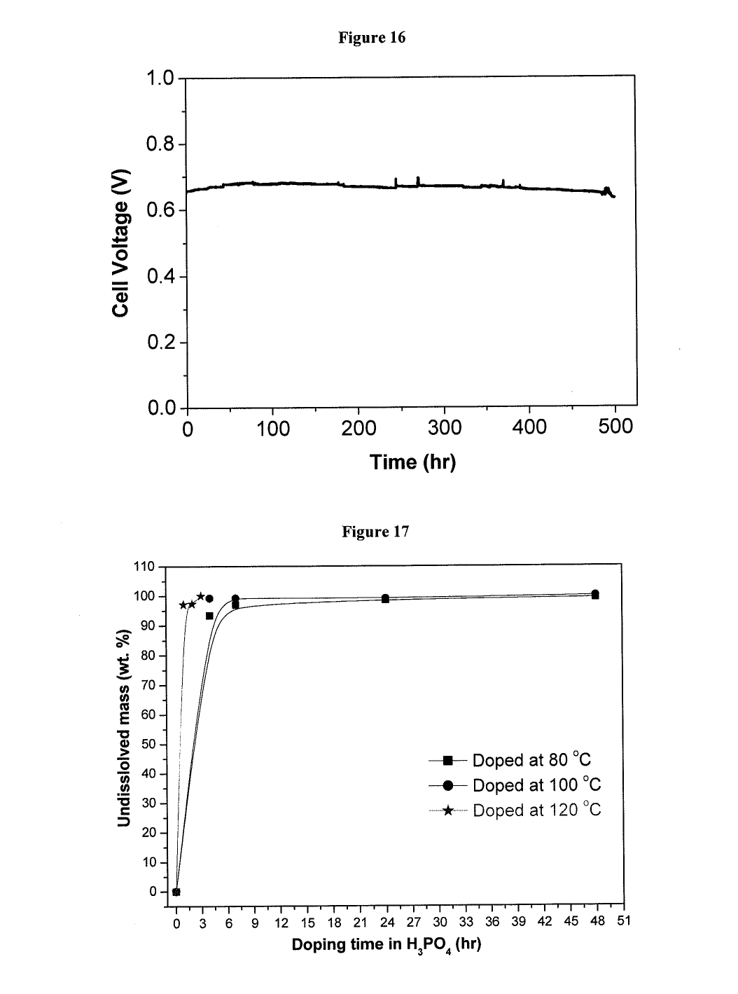

The active area of the membrane electrode assemblies (MEAs) was 25 cm². The current-voltage (polarization) curves were recorded at different temperatures between 180 and 230° C. using dry gases H₂/O₂ with stoichiometric ratio of 1.2 and 2, respectively. In FIG. 13 are depicted the polarization curves of the cross-linked with the bisazide copolymer 3 with R═SO₂ and x=70, y=0, z=30 at different temperatures. The current density at cell voltage of 500 mV is 690 mA/cm² at 180° C., while at 225° C. is increased to 770 mA/cm². This performance is similar or superior compared to references related to the performance of PBI or other high temperature polymer electrolytes. (Q. Li, J. O. Jensen, R. F. Savinell, N. J. Bjerrum, Progress in Polymer Science 2009, 34, 449-477). Other characteristic examples of polarization curves in the same temperature range are given in FIGS. 14 and 15, for the cross-linked copolymer 4 with m+o=60, n+p=40, o+p=15, q=0, r=0 and for the cross-linked in phosphoric acid copolymer 3 with R═SO₂ and x=50, y=30, z=20, respectively. Furthermore, in FIG. 16 it is represented the stable performance of the cross-linked with bisazide copolymer 3 with R═SO₂ and x=60, y=24, z=16, for nearly 550 h at 210° C. at a current density of 0.2 A/cm².

### EXAMPLES

### Example 1

### Synthesis of Copolymer 1 with x=70, y=20, z=10

A degassed round bottom flask equipped with a Dean-Stark trap, was charged with bis(4-fluorphenyl)sulphone (5.9 mmol, 1.5 g), 2,5-bis(4-hydroxyphenyl)pyridine (3.54 mmol, 0.93 g), 3,3′,5,5′-tetramethyl-[1,1′-diphenyl]-4,4′-diol (1.77 mmol, 0.43 g) 3,5-dihydroxybenzoic acid (0.59 mmol, 0.09 g), K₂CO₃ (1.6 g). N-methylpyrrolidinone (25 mL) and toluene (5 mL). The mixture was heated at 150° C. for 24 h and at 180° C. for 48 h under inert argon atmosphere. The viscous solution was precipitated in HCl (0.01M). The precipitated copolymer 1 was filtered, washed several times with water and methanol and dried under high vacuum at 80° C. for 2 d.

### Example 2

### Synthesis of Copolymer 2 with R═CH₃ and x=70, y=0, z=30

To a degassed round bottom flask equipped with a Dean-Stark trap, bis(4-fluorophenyl)-sulfone (2.67 mmol, 0.6788 g), 2,5-bis(4-hydroxy-phenyl)pyridine (1.87 mmol, 0.49 g), 2,5-di(methyl phenyl)benzene-1,4-diacetate (0.801 mmol, 0.3 g), K₂CO₃ (3.1 mol, 0.427 g), KOH (2.67 mmol, 0.149 g), DMF (10 mL) and toluene (3 mL) were added. The mixture was heated at 150° C. for 24 h and at 180° C. for 48 h under inert argon atmosphere. The viscous product was diluted in DMF and this solution was precipitated in a 10 fold excess of 5/1 methanol/water mixture. The copolymer 2 was filtered, stirred in H₂O at 60° C. for 2 h, filtered and washed with water and hexane and dried under high vacuum for 2 d at 80° C.

### Example 3

### Membrane Fabrication and Doping Procedure

0.5 g of the copolymer 2 with R═CH₃ (x=67) were diluted in 12 ml of DMA at room temperature. The solution was filtrated and was cast on a petri dish where the solvent slowly evaporated at 70° C. The resulting membrane was dried under vacuum at 160° C. for 3 days and then impregnated in H₃PO₄ 85 wt % at 100° C.

### Example 4

### Cross-Linking Through the Formation of Oxadiazoles of Copolymer 1 with x=55, y=0, z=45

0.4 g of copolymer 1 with x=55, y=0, z=45 were dissolved in 8 ml N-methylpyrrolidone. Then 0.07 g terepthalic dihydrazide were mixed with 0.04 g calcium chloride in 0.14 g dry pyridine and 0.4 g diphenyl phosphite in 2 ml N-methylpyrrolidone. The two solutions were mixed and stirred at 100° C. for 5 h. The final solution was purred to a Petri dish (d=5.5 cm). Then the dish was covered and left at reflux conditions in the oven at 140° C. for 24 h. Finally, the dish was uncovered and the solvent was left to evaporate at 140° C. for 24 h. The prepared membrane was washed with 200 ml methanol for 5 h and dried under high vacuum at 280° C. for 24 h.

### Example 5

Cross-Linking Through Oxadiazole of Copolymer 1 with x=70, y=20, z=10.

0.4 g of copolymer 1 (x=70, y=20, z=10) were dissolved in 8 ml N-methylpyrrolidinone. Then 0.017 g terephthalic dihydrazide were mixed with 0.01 g calcium chloride in 0.05 g of dry pyridine and 0.1 g diphenyl phosphite in 2 ml N-methylpyrrolidinone. The two solutions were mixed and stirred at 100° C. for 5 h. The final solution was purred to a Petri dish (d=5.5 cm). Then the dish was covered and left at reflux conditions in oven at 140° C. for 24 h. Finally, the dish was uncovered and the solvent was left to evaporate at 140° C. for 24 h. The prepared membrane was washed with 200 ml methanol for 5 h and dried under high vacuum at 280° C. for 24 h.

### Example 6

### Synthesis of Copolymer 3 with R═SO₂ and x=50, y=20, z=30

To a degassed flask equipped with a Dean-Stark trap, bis(4-fluorophenyl)sulfone (3.93 mmol, 1.000 g), 2,5-bis(4-hydroxy-phenyl)pyridine (1.96 mmol, 0.5170 g), 2,5-bis(3-pyridine) phenyl-1,4-diol (0.78 mmol, 0.2076 g), 2,2′-diallyl bisphenol A (1.11 mmol, 0.3639 g), K₂CO₃ (4.56 mmol, 0.6296 g), toluene (5.0 mL) and N-Methylpyrrolidone (15.0 mL), were added. The mixture was stirred at 150° C. for 16 h and at 190° C. for 8 h under argon atmosphere. The viscous solution was precipitated in methanol. The precipitated copolymer 3 was filtered off, stirred in water at 80° C., and dried at 80° C. under vacuum for 24 h.

### Example 7

Cross-Linking with the Use of Bisazide of Copolymer 3 with R═SO₂ and x=70, y=0, z=30

0.250 g of copolymer 3 with R═SO₂ and x=70, y=0, z=30 were diluted in 10 ml of dimethylacetamide, DMAc. To this solution 0.102 g of the bisazide were added and the mixture was stirred for 2 h. The solution was filtrated and purred onto a covered Petri dish which was left in the oven at 150° C. for 18 h and at 200° C. for another 18 h. The produced cross-linked membrane was dried under vacuum at 160° C. for 3 d.

### Example 8

### General Procedure of Cross-Linking in Phosphoric Acid of Copolymer 3

The casted membranes were immersed in phosphoric acid 85% at temperatures ranging from 80° C. to 150° C. for 1-48 h. Then the membranes were immersed in boiling deionized water for 2 days in order to remove the acid and were dried under vacuum for 24 h at 120° C. In this way the solubility of the obtained membranes in DMAc at 55° C., is gradually reduced which is a strong indication of the formation of a successful cross-linked network. A characteristic example of the dependence of doping time in the membrane's solubility in DMAc at 55° C. versus the doping time in phosphoric acid is given in FIG. 17 for the cross-linked copolymer 3 with R═SO₂ and x=60, y=24, z=16 which were doped in phosphoric acid at 80° C.

### Example 9

### Synthesis of Copolymer 2 with R═OH and x=60, y=0, z=40

To a degassed flask equipped with a Dean-Stark trap, a mixture of bis(4-fluorophenyl)sulfone (2.33 mmol, 0.5916 g), 1,4-bis(4-methoxyphenyl)-2,5-dihydroxybenzene (0.93 mmol, 0.3000 g), 2,5-bis(4-hydroxy-phenyl)pyridine (1.40 mmol, 0.3676 g), K₂CO₃ (2.70 mmol, 0.373 g), DMAc (13 ml) and toluene (4.5 ml) was added. The reaction mixture was stirred at 150° C. for 24 h under argon. After removal of the azeotropic mixture of the formed water with toluene, the temperature was raised gradually at 180° C. The reaction mixture was stirred at this temperature for 6 h and the obtained viscous solution was precipitated in MeOH. The copolymer 2 with R═OCH₃ was stirred in water at 60° C., filtered, washed with hexane and dried at 100° C. under vacuum for 1 d.

Boron tribromide (0.35 ml, 3.59 mmol) was added dropwise to a solution of copolymer 2 with R═OCH₃ (x=60, y=0, z=40) (1.00 g, 2.00 mmol) in dry CH₂Cl₂. The mixture was stirred for 12 h and precipitated to a saturated NaHCO₃ solution. The solid was stirred in this solution for 3 more h and then filtered and washed with water and hexane. For further purification the product was dissolved in hot DMAc and re-precipitated in water. The obtained copolymer 2 with R═OH was dried under vacuum at 100° C. for 1 d.

### Example 10

### Cross-Linking of Copolymer 2 with R═OH and x=60, y=0, z=40

(0.30 mmol, 0.146 g) of copolymer 2 with R═OH and x=60, y=0, z=40 was dissolved in DMAc (3 mL). Then, K₂CO₃ (0.34 mmol, 0.048 g) was added and the reaction mixture was stirred at 55-60° C. for 1.5 h. Decafluorobiphenyl (0.02 mmol, 0.0073 g) was dissolved in DMAc (0.5 mL). The two solutions were mixed, filtered and poured onto a covered petri dish which was placed in an oven for 16 h at 80° C. Then the cover was removed and the solvent was left to evaporate at 120° C. To remove any excess of the solvent, the membranes were dried for 3 d under vacuum at 160° C.

Similar synthetic procedures were used for the synthesis of analogous copolymers with different monomer contents or/and using analogue aromatic difluorides.

### Example 11

### Synthesis of Copolymer 4 with, m+o=60, n+p=40, o+p=15, q=0, r=0

To a degassed flask equipped with a Dean-Stark trap 2,5-Bis(4-hydroxy-phenyl)pyridine (1.30 mmol, 0.3438 g), 3,3′,5,5′-tetramethyl-[1,1′-biphenyl]-4,4′-diol (0.87 mmol, 0.2113 g), bis(4-fluorophenyl)-sulfone (1.85 mmol, 0.4713 g), 3,3′-bis(4-vinylbenzene)-4,4′-difluorodiphenyl sulfone (0.32 mmol, 0.1432 g), potassium carbonate (2.68 mmol, 0.3699 g), N-methylpyrrolidone (5.5 mL) and toluene (2 mL) were added. The mixture was degassed under argon and stirred at 130° C. for 16 h. Thereafter, the temperature was increased to 140° C. for about 24 h. The brownish viscous product was cooled down at 50° C., diluted using N-methylpyrrolidone and precipitated in a 10 fold excess of 3/1 methanol/water mixture. The copolymer 4 was filtered, washed with water and hexane and dried at 40° C. under vacuum for 2 days.

### Example 12

### General Procedure of the Thermal Cross-Linking of Copolymers 5

The copolymers 5 were dissolved in DMAc at room temperature. The 4-% wt solutions of the different copolymers bearing styrene groups were cast on petri dishes and the solvent slowly evaporated at 80° C. The resulting membranes were dried under vacuum at 140° C. for 3 days. Thermal treatment of the membranes in an oven at temperatures ranging from 200° C. to 300° C. for 12 h under argon atmosphere produced the cross-linked membranes.

What is claimed is:

1. A polymer electrolyte comprising: at least one aromatic polyether copolymer with main chain pyridine groups and side chain carboxylic acid or carboxylic ester or toluene or methoxy phenyl or hydroxyl phenyl or propenyl or styrene groups and/or pyridine groups, which have the ability to be covalently cross-linked.

2. The polymer electrolyte of claim 1, wherein said aromatic polyether copolymer has a general structural formula selected from the group consisting of: 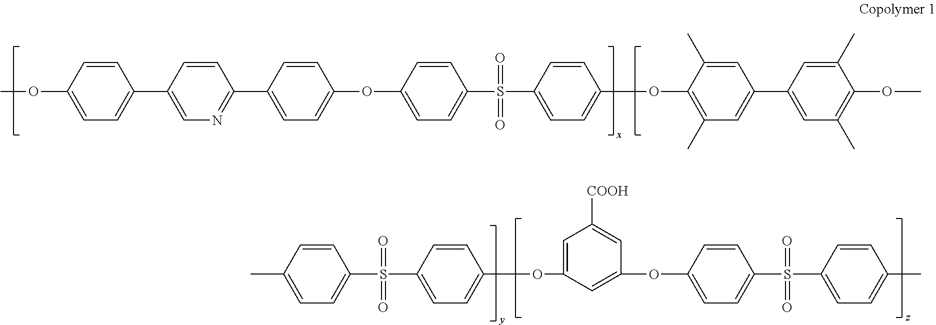
wherein x is from about 5 to about 95%;
y is from about 0 to about 95%;
z is from about 5 to about 95%; and
wherein x+y+z=100%; 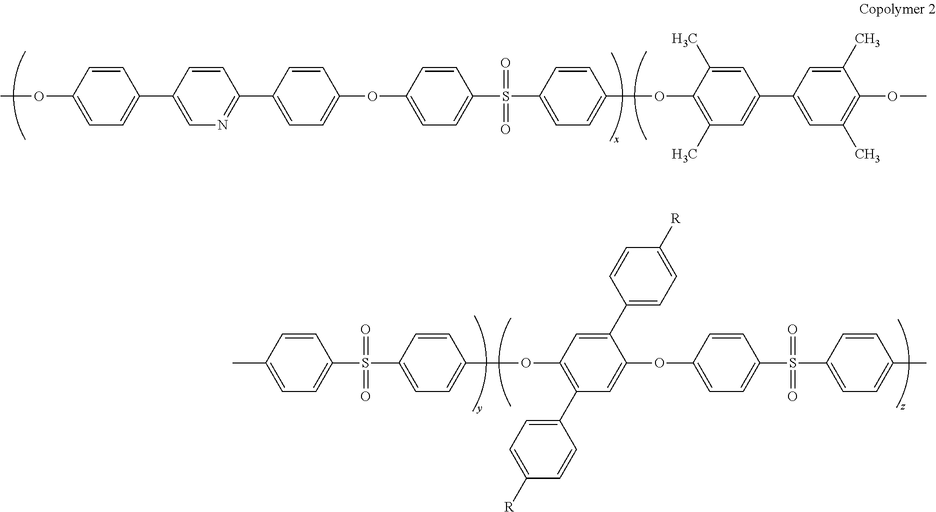
wherein x is from about 50 to about 80%;
y is from about 0 to about 50%;
z is from about 5 to about 50%;
wherein x+y+z=100%; and
wherein R is selected from the group consisting of —CH═CH₂, CH₃, COOH, COOCH₃, OCH₃, and OH; 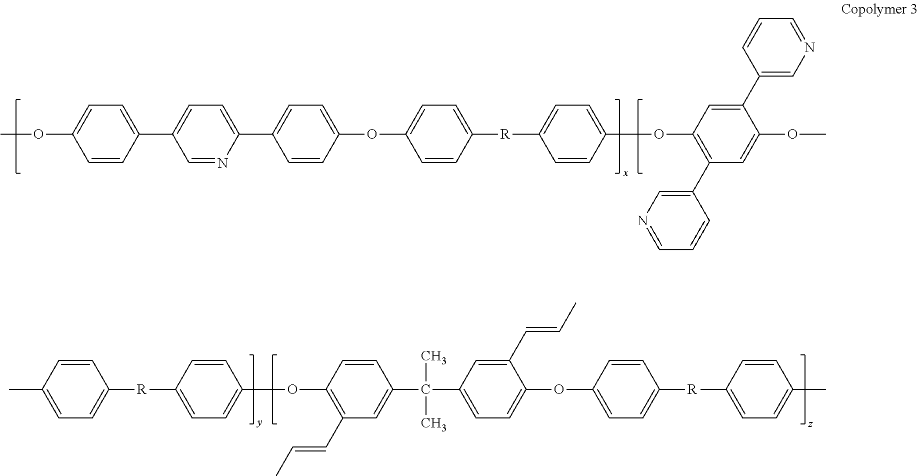
wherein x is from about 50 to about 70%;
y is from about 0 to about 30%;
z is from about 10 to about 30%;
wherein x+y+z=100%; and
wherein R is selected from the group consisting of SO₂, and OP-Ph; 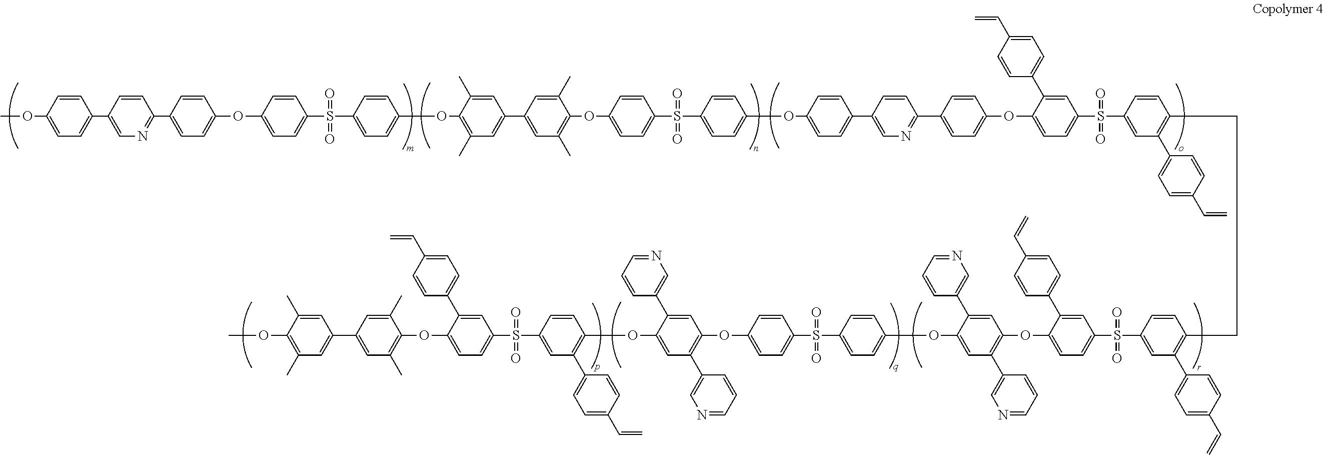
Wherein m is from about 10 to about 80%;
n is from about 20 to about 40%;
o is from about 2 to about 30%;
p is from about 2 to about 30%;
q is from about 0 to about 30%;
r is from about 0 to about 30%;
wherein m+n+o+p+q+r=100%; and 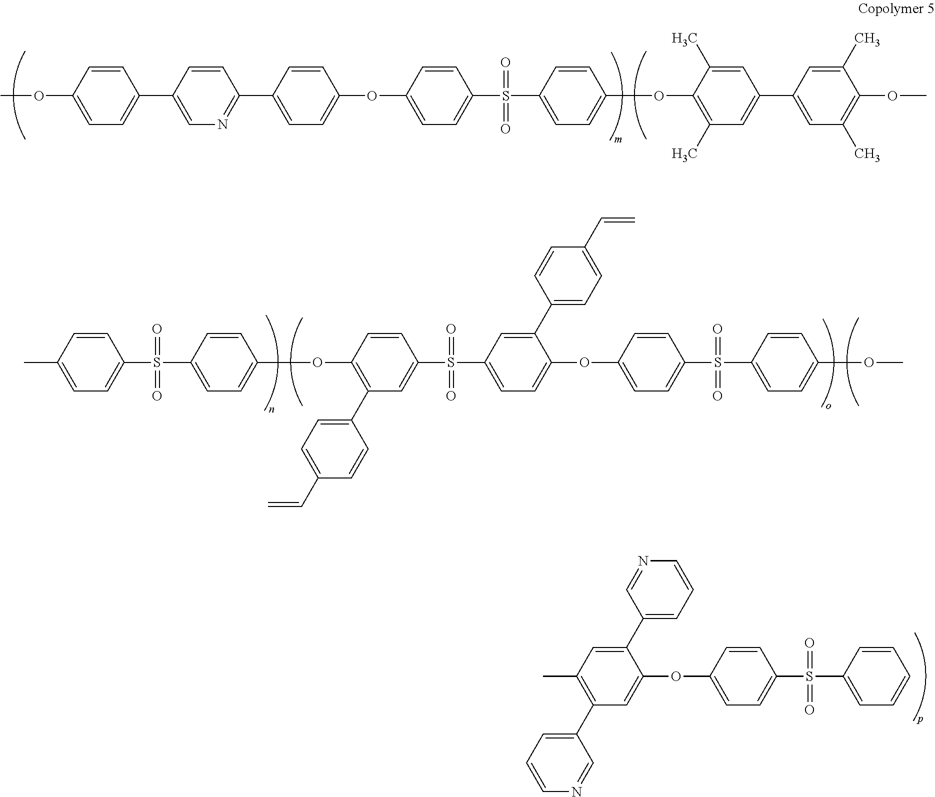
wherein m is from about 40 to about 90%;
n is from about 0 to about 40%;
o is from about 5 to about 40%;
p is from about 0 to about 30%; and
wherein m+n+o+p=100%.

3. The polymer electrolyte of claim 2, wherein said aromatic polyether copolymer has the general structural formula of Copolymer 1 or Copolymer 2, and has main chain pyridine groups and side chain carboxylic acid groups.

4. The polymer electrolyte of claim 2, wherein said aromatic polyether copolymer has the general structural formula of Copolymer 2, and has main chain pyridine groups and side chain hydroxyl phenyl.

5. The polymer electrolyte of claim 2, wherein said aromatic polyether copolymer has the general structural formula of Copolymer 3, and has main chain and side chain pyridine groups and side chain propenyl groups.

6. The polymer electrolyte of claim 2, wherein said aromatic polyether copolymer has the general structural formula of Copolymer 2 or Copolymer 4 or Copolymer 5, and has main and side chain pyridine groups and side styrene groups.

7. The polymer electrolyte of claim 2, wherein said aromatic polyether copolymer has the general structural formula of Copolymer 1, and is doped with a polyprotic acid at an amount of about 160-350 wt %.

8. The polymer electrolyte of claim 2, wherein said aromatic polyether copolymer has the general structural formula of Copolymer 2, and is doped with a polyprotic acid at an amount of about 180-400 wt %.

9. The polymer electrolyte of claim 2, wherein said aromatic polyether copolymer has the general structural formula of Copolymer 3, and is doped with a polyprotic acid at an amount of about 100-350 wt %.

10. The polymer electrolyte of claim 2, wherein said aromatic polyether copolymer has the general structural formula of Copolymer 4, and is doped with a polyprotic acid at an amount of about 100-400 wt %.

11. The polymer electrolyte of claim 2, wherein said aromatic polyether copolymer has the general structural formula of Copolymer 5, and is doped with a polyprotic acid at an amount of about 100-400 wt %.

12. A method for cross-linking aromatic polyethers of claim 2, said method comprising:
at least one of (a) heat treating said aromatic polyether copolymers, or (b) reacting said aromatic polyether copolymer with at least one cross-linking agent.

13. A method for cross-linking aromatic polyethers of claim 3, said method comprising:
reacting said aromatic polyether copolymers with at least (a) ditetrazoles or poly(tetrazole)s or dihydrazides to form oxadiazole rings, or (b) tetramines or poly(diamine)s to form imidazole rings.

14. A method for cross-linking aromatic polyethers of claim 4, said method comprising:
reacting said aromatic polyether copolymers with aromatic fluorides to form aromatic ether cross-linked bonds.

15. A method for cross-linking aromatic polyethers of claim 5, said method comprising:
(a) thermally treating said aromatic polyether copolymers at about 80° C.-150° C. in the presence of phosphoric acid, or (b) reacting said aromatic polyether copolymers with bisazide at about 150° C. to about 250° C. to form aziridines or secondary amines.

16. A method for cross-linking aromatic polyethers of claim 6, said method comprising:
(a) thermally treating said aromatic polyether copolymers at about 200° C. to about 300° C., or (b) at about 80° C.-150° C. in the presence of phosphoric acid.

17. The cross-linked polymer electrolyte produced form the method of claim 12, and doped with a polyprotic acid at an amount of about 100 to about 400% wt.

18. The cross-linked polymer electrolyte produced form the method of claim 13, and doped with a polyprotic acid at an amount of about 100 to about 400% wt.

19. The cross-linked polymer electrolyte produced form the method of claim 14, and doped with a polyprotic acid at an amount of about 100 to about 400% wt.

20. The cross-linked polymer electrolyte produced form the method of claim 15, and doped with a polyprotic acid at an amount of about 100 to about 400% wt.

21. The cross-linked polymer electrolyte produced form the method of claim 16, and doped with a polyprotic acid at an amount of about 100 to about 400% wt.

22. The cross-linked polymer electrolyte of claim 17, wherein said polyprotic acid is present in an amount of about 180 to about 300% wt.

23. The cross-linked polymer electrolyte of claim 22, wherein the polyprotic acid comprises phosphoric acid.

24. A layered membrane electrode assembly comprising an anode electrode, a cathode electrode and a polymer electrolyte of claim 23.
